(19) United States
(12) Patent Application Publication
(10) Pub. No.: US 2026/0259687 A1
(43) Pub. Date: Sep. 3, 2026

(54) INTERACTIVE DISPLAY WITH TOUCH FRAME, USB SELECTING SWITCH, AND SCALER FOR MULTI-COMPUTER CONNECTIVITY

(71) Applicant: Flatfrog Laboratories AB, Lund (SE)

(72) Inventors: Tomas Christiansson, Torna Hällestad (SE); Nicklas Ohlsson, Bunkeflostrand (SE); Karl Johan Anders Perntz, Billeberga (SE)

(21) Appl. No.: 19/489,238

(22) PCT Filed: Jun. 4, 2024
(86) PCT No.: PCT/SE2024/050552

§ 371 Date: Dec. 1, 2025

(30) Foreign Application Priority Data
Jun. 9, 2023 (SE) 2330267-2

(51) Int. Cl. G06F 3/14; G06F 3/041; G06T 3/40

(52) U.S. Cl. CPC G06F 3/14; G06F 3/041; G06T 3/40

(57) ABSTRACT

An interactive display system includes a touch frame connected to a USB selecting switch through a GPIO port and a first data port. A scaler is connected to the touch frame through a second data port and is configured to send commands to the touch frame to configure the GPIO port to make the USB selecting switch connect to a computer that is currently connected to a display screen. The USB selecting switch is connected to a USB port of one or more computers, and the scaler is connected to a display port of one or more computers and configured to select which computer to connect the display screen to. The system also includes the display screen.

### FIELD

The technology relates to the field of interactive display systems, specifically focusing on touch-enabled displays and their integration with multiple computers and devices for seamless interaction and control. This field encompasses various aspects of hardware and software components, including touch frames, USB selecting switches, scalers, display screens, and computer connectivity.

### BACKGROUND

Interactive displays have become increasingly popular in various settings, such as educational institutions, corporate offices, and public spaces, due to their ability to facilitate collaboration and enhance user engagement. These displays typically combine a touch-sensitive surface with a display screen, allowing users to interact with the content displayed on the screen using touch inputs. In many cases, interactive displays are connected to one or more computers, which provide the content and processing capabilities required for the display to function.

In the prior art, interactive displays have been designed with various configurations and components to enable touch-based interaction and connectivity with computers. One common configuration involves connecting a touch frame to a computer via a USB port, which allows the computer to receive touch input data from the touch frame. Additionally, a scaler may be used to process and convert the video signal from the computer to a format compatible with the display screen. The scaler is typically connected to the computer through a display port, such as HDMI, DisplayPort, VGA, or DVI, among others.

However, there are several shortcomings associated with the prior art interactive displays. One issue is the complexity of managing multiple connections between the touch frame, scaler, and computers, particularly when multiple computers are connected to the interactive display. This can lead to a cluttered and confusing setup, making it difficult for users to switch between different computers and manage the connections effectively.

Another problem with prior art interactive displays is the lack of flexibility in selecting which computer to connect to the display screen and touch frame. In many cases, users may need to manually switch cables or reconfigure settings to change the connected computer, which can be time-consuming and inconvenient.

Furthermore, prior art interactive displays may not provide an efficient and seamless way to control the touch frame and USB selecting switch, which can result in a less user-friendly experience. For example, the scaler may not be able to directly control the touch frame and USB selecting switch, requiring additional components or manual intervention to configure the connections.

In summary, the prior art interactive displays suffer from various limitations, including complex and cluttered connections, limited flexibility in selecting connected computers, and inefficient control of touch frame and USB selecting switch.

### SUMMARY

In a first aspect, the invention provides an interactive display system comprising a touch frame connected to a USB selecting switch through a GPIO port and a first data port, a scaler connected to the touch frame through a second data port and configured to send commands to the touch frame to configure the GPIO port to make the USB selecting switch connect to a computer that is currently connected to a display screen, the USB selecting switch connected to a USB port of one or more computers, the scaler connected to a display port of one or more computers and configured to select which computer to connect the display screen to, and the display screen.

Optionally, the first data port is a USB port. The second data port may be selected from the group consisting of USB and UART. The scaler may be connected to the display screen through a T-con interface. The T-con interface may be selected from the group consisting of Vx1, eDP, LVDS, MIPI DSI, and DisplayPort. The display port may be selected from the group consisting of HDMI display port, DisplayPort (DP) port, VGA display port, DVI display port, Thunderbolt display port, Mini DisplayPort (mDP) port, USB-C display port, and eDP. The scaler may run an operating system selected from the group consisting of Android, Windows, Linux, and no operating system.

In a second aspect, the invention provides a method of using the interactive display system, comprising the steps of connecting a touch frame to a USB selecting switch through a GPIO port and a first data port, connecting a USB selecting switch to a computer(s), connecting a scaler to a display screen, using the scaler to select which computer to connect to the display screen, using the USB selecting switch to switch between different connected computers, and using the touch feature of the touch frame to interact with the selected computer displayed on the screen.

Optionally, the first data port is a USB port. The second data port may be selected from the group consisting of USB and UART.

### BRIEF DESCRIPTION OF THE DRAWINGS

The disclosure will now be described in more detail with reference to the accompanying drawings, in which:

FIG. 1 is a schematic diagram illustrating the components and connections of the interactive display system 100;

FIG. 2 is a flowchart depicting the method of using the interactive display system 100.

### DETAILED DESCRIPTION

The present disclosure will now be described in detail with reference to example embodiments. It should be understood that these example embodiments are provided for illustrative purposes only and are not intended to limit the scope of the present disclosure.

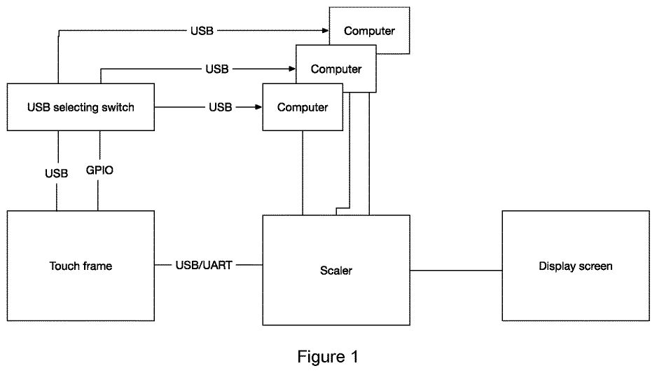

According to an embodiment shown in FIG. 1, an interactive display system 100 is provided, which includes a touch frame 10, a USB selecting switch 20, a scaler 40, and a display screen 50. The touch frame 10 is connected to the USB selecting switch 20 through a GPIO port and a first data port. The scaler 40 is connected to the touch frame 10 through a second data port and is configured to send commands to the touch frame 10 to configure the GPIO port to make the USB selecting switch 20 connect to a computer 30 that is currently connected to the display screen 50. The USB selecting switch 20 is connected to a USB port of one or more computers 30. The scaler 40 is connected to a display port of one or more computers 30 and is configured to select which computer 30 to connect the display screen 50 to. The display screen 50 is provided for displaying the content from the selected computer 30.

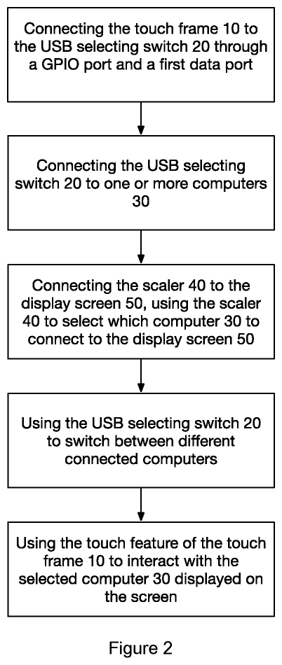

Referring to FIG. 2, a method of using the interactive display system 100 is provided. The method includes the steps of connecting the touch frame 10 to the USB selecting switch 20 through a GPIO port and a first data port, connecting the USB selecting switch 20 to one or more computers 30, connecting the scaler 40 to the display screen 50, using the scaler 40 to select which computer 30 to connect to the display screen 50, using the USB selecting switch 20 to switch between different connected computers 30, and using the touch feature of the touch frame 10 to interact with the selected computer 30 displayed on the screen.

### 1. Hardware Configuration

In one example, the hardware configuration of the interactive display system 100 comprises a touch frame 10, a USB selecting switch 20, a scaler 40, and a display screen 50. These components are interconnected to provide an efficient and user-friendly interactive display system that allows users to switch between different connected computers 30 and interact with the selected computer using the touch feature of the touch frame 10.

### 1.1. Touch Frame and USB Selecting Switch Connection

In some examples, the touch frame 10 is connected to the USB selecting switch 20 through a GPIO port and a first data port. This connection allows the touch frame 10 to communicate with the USB selecting switch 20 and enables the scaler 40 to send commands to the touch frame 10 to configure the GPIO port to make the USB selecting switch 20 connect to the computer 30 that is currently connected to the display screen 50. This configuration provides an efficient and seamless way to switch between different connected computers 30 and interact with the selected computer using the touch feature of the touch frame 10.

### 1.1.1. GPIO Port and First Data Port Configuration

In some examples, the GPIO port and the first data port are configured to provide an efficient and reliable connection between the touch frame 10 and the USB selecting switch 20. The GPIO port allows for the transmission of control signals between the touch frame 10 and the USB selecting switch 20, while the first data port enables the transmission of data between these components.

### 1.1.1.1. USB Port As First Data Port

In one example, the first data port is a USB port. The use of a USB port as the first data port provides a widely compatible and easily accessible connection option for the touch frame 10 and the USB selecting switch 20. This allows the transmission of touch interaction data from the touch frame all the way to the currently selected computer.

### 1.2. Scaler and Touch Frame Connection

In some examples, the scaler 40 is connected to the touch frame 10 through a second data port. This connection allows the scaler 40 to communicate with the touch frame 10 and send commands to configure the GPIO port, as described above. The second data port may be selected from various options, such as USB or UART, depending on the specific requirements of the interactive display system 100.

### 1.2.1. Second Data Port Configuration

In one example, the second data port is configured to provide an efficient and reliable connection between the scaler 40 and the touch frame 10. The choice of the second data port may depend on the specific requirements of the interactive display system 100 and the compatibility of the components.

### 1.2.1.1. USB and UART as Second Data Port Options

In some examples, the second data port is selected from the group consisting of USB and UART. Both USB and UART provide reliable and efficient data transmission options for connecting the scaler 40 and the touch frame 10. The choice between USB and UART may depend on factors such as the compatibility of the components, the desired data transmission speed, and the overall design of the interactive display system 100. Touch can be used to interact with scaler menus, e.g. brightness/contrast and source selection) as well as with other apps running on the scaler, e.g. whiteboard, web browser etc.

### 1.3. Scaler and Display Screen Connection

In one example, the scaler 40 is connected to the display screen 50 through a T-con interface. The T-con interface allows for the transmission of video signals between the scaler 40 and the display screen 50, enabling the display of content from the selected computer 30 on the display screen 50.

### 1.3.1. T-con Interface Types

In some examples, the T-con interface is selected from the group consisting of Vx1, eDP, LVDS, MIPI DSI, and DisplayPort. These different T-con interface types provide various options for connecting the scaler 40 and the display screen 50, depending on the specific requirements of the interactive display system 100 and the compatibility of the components.

### 1.4. Display Port and Computer Connection

In one example, the scaler 40 is connected to a display port of one or more computers 30. This connection allows the scaler 40 to receive video signals from the connected computer(s) 30 and display the content on the display screen 50. The scaler 40 is configured to select which computer 30 to connect the display screen 50 to, providing users with the ability to switch between different connected computers 30 and interact with the selected computer using the touch feature of the touch frame 10.

### 1.4.1. Display Port Types

In some examples, the display port is selected from the group consisting of HDMI display port, DisplayPort (DP) port, VGA display port, DVI display port, Thunderbolt display port, Mini DisplayPort (mDP) port, USB-C display port, and eDP. These different display port types provide various options for connecting the scaler 40 and the computer(s) 30, depending on the specific requirements of the interactive display system 100 and the compatibility of the components.

### 2. Method of Using the Interactive Display System

The method of using the interactive display system 100 involves several steps, including connection and configuration of the various components, switching between connected computers 30, and interacting with the selected computer 30 using the touch frame 10. In some examples, the method may comprise additional optional features that enhance the functionality and user experience of the interactive display system 100.

### 2.1. Connection and Configuration Steps

In one example, the method begins with connecting the touch frame 10 to the USB selecting switch 20 through a GPIO port and a first data port. The first data port may be a USB port. This connection allows the touch frame 10 to communicate with the USB selecting switch 20 and enables the touch frame 10 to control the USB selecting switch 20 based on the commands received from the scaler 40.

Next, the USB selecting switch 20 is connected to one or more computers 30 through their respective USB ports. This connection enables the USB selecting switch 20 to selectively establish a connection between the touch frame 10 and any of the connected computers 30, allowing the user to interact with the selected computer 30 using the touch frame 10.

The scaler 40 is then connected to the touch frame 10 through a second data port, which may be selected from the group consisting of USB and UART. This connection allows the scaler 40 to send commands to the touch frame 10 to configure the GPIO port, making the USB selecting switch 20 connect to the computer 30 that is currently connected to the display screen 50.

The scaler 40 is also connected to the display screen 50 through a T-con interface, which may be selected from the group consisting of Vx1, eDP, LVDS, MIPI DSI, and DisplayPort. This connection allows the scaler 40 to transmit the display data from the selected computer 30 to the display screen 50.

Finally, the scaler 40 is connected to the display port of one or more computers 30. The display port may be selected from the group consisting of HDMI display port, DisplayPort (DP) port, VGA display port, DVI display port, Thunderbolt display port, Mini DisplayPort (mDP) port, USB-C display port, and eDP, as described in claim 6. This connection allows the scaler 40 to receive display data from the connected computers 30 and transmit it to the display screen 50.

### 2.2. Switching Between Connected Computers

In some examples, the method may comprise using the scaler 40 to select which computer 30 to connect to the display screen 50. The scaler 40 may run an operating system selected from the group consisting of Android, Windows, Linux, and no operating system, as described in claim 7. The scaler may provide a user interface that allows the user to select the desired computer 30 to be connected to the display screen 50.

Once the user selects a computer 30, the scaler 40 sends commands to the touch frame 10 to configure the GPIO port, making the USB selecting switch 20 connect to the selected computer 30. The scaler 40 also establishes a connection between the display port of the selected computer 30 and the display screen 50, allowing the display data from the selected computer 30 to be displayed on the display screen 50.

### 2.3. Touch Frame Interaction with Selected Computer

In some examples, the method may comprise using the touch feature of the touch frame 10 to interact with the selected computer 30 displayed on the screen. The touch frame 10 detects the user's touch inputs and sends the corresponding touch data to the selected computer 30 through the USB selecting switch 20. The selected computer 30 processes the touch data and updates the display data accordingly, allowing the user to interact with the selected computer 30 using the touch frame 10.

The advantages of the claimed features include efficient use of cables, as the USB selecting switch 20 is connected to the touch frame 10 using USB and GPIO, rather than being controlled by the scaler 40 directly. This configuration allows for a more streamlined and organized connection between the components of the interactive display system 100.

### 2.4. Touch Frame Interaction With Scaler

In some examples, the method may also comprise using the touch frame 10 to interact with the scaler 40 to control various aspects of the display and access built-in applications or input sources. This may include controlling the display properties, such as brightness and contrast, running built-in apps like a whiteboard, internet browser, photo gallery, or slideshow, and selecting the input source from the connected computers 30.

These interactions can be implemented using an on-screen display (OSD) provided by the scaler 40. When the OSD is present, the scaler 40 can turn off reporting from the touch frame 10 via the first data port for the whole touch frame area or the parts of the touch frame that are covered by the OSD. This allows the user to interact with the OSD without unintentionally interacting with the underlying display data from the selected computer 30.

The scaler 40 mixes the OSD on top of the video coming from the selected input source (computer), allowing the user to control display properties, access built-in apps, and select input sources using the touch frame 10. This direct interaction with the scaler 40 enhances the user experience and overall functionality of the interactive display system 100.

1.-10. (canceled)

11. An interactive display system comprising:
a touch frame connected to a USB selecting switch through a GPIO port and a first data port;
a scaler connected to the touch frame through a second data port and configured to send commands to the touch frame to configure the GPIO port to make the USB selecting switch connect to a computer that is currently connected to a display screen;
the USB selecting switch connected to a USB port of one or more computers;
the scaler connected to a display port of one or more computers and configured to select which computer to connect the display screen to; and
the display screen.

12. The interactive display system according to claim 11, wherein the first data port is a USB port.

13. The interactive display system according to claim 11, wherein the second data port is selected from the group consisting of USB and UART.

14. The interactive display system according to claim 11, wherein the scaler is connected to the display screen through a T-con interface.

15. The interactive display system according to claim 14, wherein the T-con interface is selected from the group consisting of Vx1, eDP, LVDS, MIPI DSI, and DisplayPort.

16. The interactive display system according to claim 11, wherein the display port is selected from the group consisting of HDMI display port, DisplayPort (DP) port, VGA display port, DVI display port, Thunderbolt display port, Mini DisplayPort (mDP) port, USB-C display port, and eDP.

17. The interactive display system according to claim 11, wherein the scaler runs an operating system selected from the group consisting of Android, Windows, Linux, and no operating system.

18. A method of using an interactive display system, the method comprising:
connecting a touch frame to a USB selecting switch through a GPIO port and a first data port;
connecting a USB selecting switch to a computer(s);
connecting a scaler to a display screen;
using the scaler to select which computer to connect to the display screen;
using the USB selecting switch to switch between different connected computers; and
using a touch feature of the touch frame to interact with the selected computer displayed on the screen.

19. The method according to claim 18, wherein the first data port is a USB port.

20. The method according to claim 18, wherein a second data port is selected from the group consisting of USB and UART.
